(19) United States
(12) Patent Application Publication
(10) Pub. No.: US 2003/0124300 A1
(43) Pub. Date: Jul. 3, 2003

(54) Manufacturing a flexible thermoinsulating device

(76) Inventors: Pierattilio Di Gregorio, Sulmona (IT); Paolo Manini, Arluno (IT)

Correspondence Address: Perkins Coie LLP, 101 Jefferson Drive, Menlo Park, CA, 94025, US

(21) Appl. No.: 10/274,291

(22) Filed: Oct. 18, 2002

(30) Foreign Application Priority Data
Oct. 19, 2001 (IT) MI2001A-002190

(51) Int. Cl. B32B 1/04

(52) U.S. Cl. 428/69; 428/71

(57) ABSTRACT

The present invention teaches a process for manufacturing a flexible thermoinsulating device, which is usable to obtain the thermal insulation of a body having non-flat surfaces. The process starts with obtaining a rigid vacuum panel comprising an evacuated envelope inside which there is disposed a filling material formed of at least a board of open cell rigid polymeric foam, to an operation of localized compression along at least a linear portion of the panel. Through this compression operation at least a slot is formed on at least a face of a board of filling material adjacent to the envelope. The present invention besides relates to the flexible thermoinsulating device obtained through said process.

### REFERENCE TO PRIORITY DOCUMENTS

This Application claims priority under 35 U.S.C. 119 to Italian Patent Application MI2001A-002190 filed on Oct. 19, 2001, which is incorporated by reference for all purposes.

### BACKGROUND

Insulating vacuum panels are known, and particularly those made with plastic materials, which are being increasingly used in all the fields wherein thermal insulation at temperatures lower than about 100° C. is required. As examples of applications there can be mentioned the walls of domestic and industrial refrigerators, of the drinks dispensing machines (wherein thermal insulation is required above all in order to separate the portion of hot drinks, generally at about 70° C., from that of cold drinks), or of the containers for isothermal transportation, for instance of drugs or cold or frozen foods, as disclosed in patent U.S. Pat. No. 5,943,876. Applications of these panels in the building fields or in the car industry are also known.

As is generally known by those skilled in the art, a vacuum panel is formed of an envelope inside which a filling material is present. The envelope has the function of preventing (or reducing as much as possible) the entrance of atmospheric gases inside the panel, so as to keep a vacuum degree compatible with the thermal insulation degree as required by the particular application. Hence, the envelope is made up of the so-called “barrier” sheets, that are characterized by a very low gas permeability, and can be formed in turn of a single component, but are more frequently multi-layered products comprised of different components. In the case of such multi-layer products, the “barrier” effect is provided by one of the composing layers, whereas the other layers play generally the role of mechanical support and protection of the barrier layer.

The filling material has mainly the function of spacing apart the two opposite faces of the envelope when a vacuum is made in the panel, and must be porous or discontinuous, so that its pores or interstices can be evacuated. This material can be inorganic, such as silica powder, glass fibers, aerogels, diatomaceous earth, etc., or organic, such as rigid foams of polyurethane or polystyrene, both in the form of boards and of powders. Since the permeation of traces of atmospheric gases into the panel is practically unavoidable, these panels contain almost always also one or more materials (generally referred to as getter materials) capable of sorbing these gases so as to maintain the pressure inside the panel at the desired values.

Owing to the rigidity of their constituting materials, the vacuum panels generally must have a planar configuration and thus they can be utilized to insulate substantially parallelepipedal bodies having planar walls, but are not suitable for bodies having curved surfaces, such as for example boilers or pipes utilized to transport oil in arctic regions.

Patent application UK 2,222,791 teaches a method to curve the so called sandwich panels, which are constituted, as it's known in the art, of two metal plates spaced apart one from the other and connected by means of a layer of plastic material. The method taught in this reference consists in forming by molding a bending groove in the metallic sheet intended to occupy the inner bending side of the panel. This groove is deformed in the bending operation, so as to become a fold penetrating in the plastic material of the inner layer.

The method can obviously be applied only to a limited range of panels. In particular, this method cannot be applied to vacuum panels whose envelope is [extremely] brittle, so that forming a bending groove thereon would certainly cause breakage, with a consequent loss of thermal insulation properties of the panel.

Another teaching, Patent EP 0,820,568 filed in the name of the company Huntsman ICI Chemicals, LLC of Wilmington Newcastle, Del. teaches a method for manufacturing non-flat vacuum insulating panels consisting in engraving the filling material, before the evacuation step, by making grooves arranged in the desired direction and having suitable width and depth, and in inserting the thus worked filling material in an envelope which is then submitted to the evacuation step. Finally the vacuum panel is sealed. At the first exposure to the atmosphere, the panel folds along the grooves assuming the final not-flat shape.

However, it has been observed that as a result of this evacuation the envelope adheres to the filling material thus getting at least partially into the above-mentioned grooves so that, when the evacuation is completed, the thickness of the panel is not uniform in each part, but it is smaller at the folding lines with respect to the planar parts of the same panel. Consequently, the thermal insulation properties of these panels are not uniform, but are reduced along such folding lines.

Another disadvantage of the known non-flat panels is the risk that the envelope, which becomes squashed within the grooves, is broken thus allowing the atmospheric gases to get into the panel and compromising finally the thermal insulation properties of the panel.

A further disadvantage of the known not-flat panels is that they bend spontaneously along said grooves as soon as they are manufactured, during the first exposure to air. Since this bending increases notably the overall dimensions of the panels, it would be rather convenient to be able to do it at the moment of the final application, so as to decrease the transportation and storage difficulties and costs.

### SUMMARY OF THE INVENTION

The present invention relates to a process for manufacturing a flexible thermoinsulating device, usable to obtain the thermal insulation of a body having not planar surfaces. The present invention provides a process for manufacturing a thermoinsulating device free from the drawbacks discussed above.

The process starts with obtaining a rigid vacuum panel comprising an evacuated envelope inside which there is disposed a filling material formed of at least a board of open cell rigid polymeric foam. Next, an operation of localized compression along at least a linear portion of the panel is performed. Through this compression operation at least a slot is formed on at least a face of a board of filling material adjacent to the envelope.

A first advantage of the thermoinsulating device of the present invention lies in the fact that it makes it possible to obtain a uniform thermal insulation of the body to which it is applied.

Furthermore, the thermoinsulating device according to the present invention is flexible and therefore it can be curved until it adheres to the walls of the body to be insulated at every time and not only during the manufacturing step. In this way, the thermoinsulating device according to the present invention can be manufactured, stored and transported to the final application place in the planar shape, and only afterwards it can be curved according to the needs.

Another advantage of the thermoinsulating device according to the present invention lies in the fact that the filling material thereof has not such grooves as to squash the envelope thus causing its breakage.

### BRIEF DESCRIPTION OF THE DRAWINGS

Further advantages and features of the thermoinsulating device according to the present invention will be apparent to those skilled in the art from the following detailed description of one embodiment thereof given with reference to the attached drawings, wherein:

FIG. 1 shows a vacuum panel which is an example of a starting product used in the invention process;

FIG. 2 shows a cross sectional view of a thermoinsulating device according to a preferred embodiment present invention, in the planar configuration; and

FIG. 3 shows a cross sectional view of the thermoinsulating device of FIG. 2, curved so as to adhere to the non-flat surface of a body to be insulated.

### DETAILED DESCRIPTION OF THE INVENTION

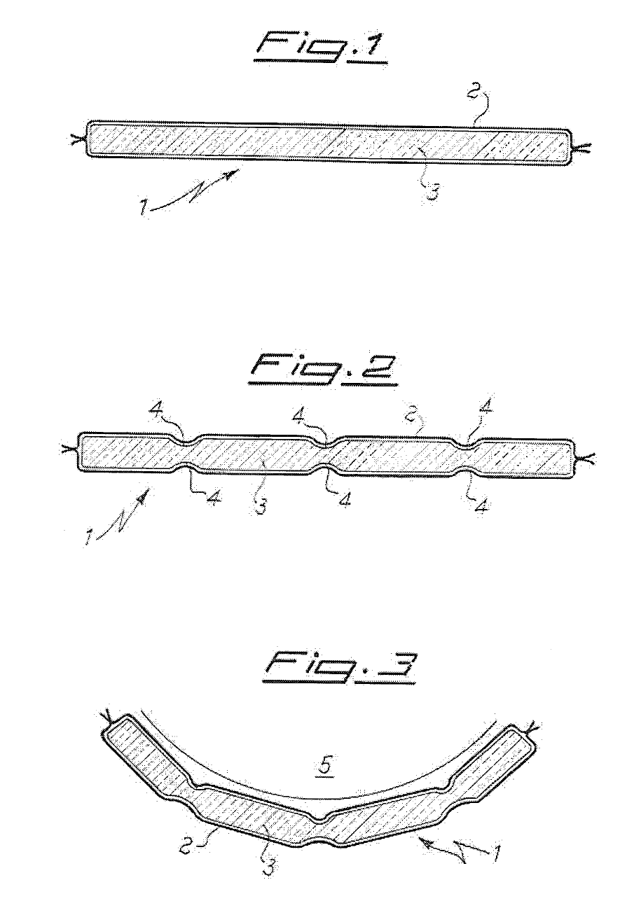

Referring to FIG. 1, there is represented a rigid vacuum panel 1, of a known type, comprising a flexible envelope 2 inside which a filling material 3 is disposed. The envelope 2 is made up of one or more barrier sheets sealed to each other so as to be gastight, whereas the filling material 3 is formed of at least a board of an open cell polymer foam, for instance polyurethane, and is kept under vacuum so that its evacuated pores perform the duty of thermal insulation.

In a preferred embodiment of the invention, the rigid vacuum panel known by those skilled in the art 1 is used as a starting material/device in order to obtain a flexible thermoinsulating device that is adaptable to the shape of the body to be insulated. The standard vacuum panel 1 is subjected to a partial compressing operation, localized along at least a linear portion of the panel 2, through which at least a slot 4 on one or both faces of the board of filling material 3 is formed, said slot being positioned in such a way as to allow the bending of panel 1 around a body to be insulated.

The forming of slot 4 is obtained without removing the filling material 3, but by only compressing it in one embodiment, which means that the thermal insulation capacity of the newly formed thermoinsulating device is not reduced at the linear portions comprising each slot 4. Despite a reduced thickness, these linear portions of filling material 3 have an improved thermal insulation capacity; it is known in the art that with equal thickness, a compressed polymeric foam has a thermal insulation capacity higher than what the same foam had before compressing it. For this reason, the thermoinsulating device in the present invention has a uniform insulation capacity.

In a preferred embodiment, with a view to obtain the insulation of a body having curved surfaces, a plurality of slots 4 are formed and disposed which optimizes the adhesion of the thermoinsulating device to the surface of said body. Should the filling material 3 be made up of a plurality of stacked boards, all of them are deformed during the compressing step of the vacuum panel 1 in the preferred embodiment, but the slots 4 become formed on the outer faces of the board adjacent to the envelope 2. The evacuation of panel 1 allows the envelope 2 to adhere to the filling material in every single part, so that the slots 4 are also evident on the surface of the thermoinsulating device according to the present invention.

In the preferred embodiment, these slots 4 are straight and cross one face of the board of the filling material 3 from side to side, thus joining for example two opposite sides or two adjacent sides of a rectangular board. The cross section of slots 4 can have any shape, being for example wedge-shaped or semicircle-shaped.

FIG. 2 illustrates the preferred embodiment of the invention, in which the slots 4 are evenly distributed on both faces of the board of filling material, i.e. for each slot 4 on a face of the board there corresponds a slot 4 on the other face. Furthermore, in the preferred embodiment, the slots 4 are all parallel to each other so that the resulting thermoinsulating device is suitable for insulating a cylindrical body 5 which is shown in FIG. 3.

However, in other embodiments of the invention, the slots on both faces of the board of filling material can be staggered, or can be arranged on one face of the board only. Furthermore, the slots 4 do not need to be parallel to each other, but can have different orientations according to the shape of the body to be insulated as can be a appreciated by those skilled in the art and also dependent on the particular final use of the panel.

The localized compressing operation on the board of filling material 3 can be carried out in any known manner to those skilled in the art. In one example, the step is completed by inserting the evacuated panel 1 between plates provided with at least a protrusion complementarily shaped with respect to the slots. To form a plurality of slots 4 on a board of filling material 3, many compression steps may be effected by moving from time to time the panel 1 between the plates, or compressing plates provided with a plurality of protrusions having suitable shape and positioning can be arranged. Particularly, the shape of the protrusions is obviously complementary with respect to the shape of the slots to be formed on the faces of the board of filling material 3. Therefore, to obtain the thermoinsulating device represented in FIGS. 2 and 3, two identical compressing plates can be used, each including a plurality of straight protrusions, parallel to each other and having a wedge-shaped cross section.

Although the above example describes particular embodiments of the invention, those skilled in the art could appreciate other techniques that would not depart from the scope and spirit of the invention. Thus, the spirit and scope of the invention can be applied beyond the above examples.

Having thus described our invention, we claim:

1. A process for manufacturing a flexible thermoinsulating device, including the steps of:
obtaining a vacuum panel, said vacuum panel comprising a vacuum envelope inside which is disposed a filling material made up of at least a board of open cells of rigid polymeric foam; and
performing a localized compression operation along at least a linear portion of said panel, forming a slot on at least one face of a board of filling material adjacent to said envelope.

2. The process as recited in claim 1, wherein compression step is performed such that said slot is substantially straight and crosses from side to side said face of the board of filling material.

3. The process as recited in claim 2, wherein said filling material includes only one board of an open cells rigid polymeric foam.

4. The process as recited in claim 3, wherein said compressing step form a plurality of slots on both surfaces of said board.

5. A process as recited in claim 4, wherein said compression is formed such that said slots are all parallel to each other.

6. The process as recited in claim 4, wherein said compression step is formed so that each slot on one face of the board corresponds to a slot on the other face of board.

7. The process as recited in claim 6 wherein said slots are all parallel to each other.

8. A process for manufacturing a flexible thermoinsulating device, including the steps of:
obtaining a vacuum panel, said vacuum panel comprising a vacuum envelope inside which is disposed a filling material made up of at least a board of open cells of rigid polymeric foam;
performing a localized compression operation along at least a linear portion of said panel, forming a slot on at least one face of a board of filling material adjacent to said envelope.
wherein said localized compressing operation is effected by pressing the vacuum panel between compressing plates, at least one of which is provided with at least a protrusion complementarily shaped with respect to the slots to be formed.

9. The process as recited in claim 8, wherein said compressing plates are both provided with a plurality of protrusions equally arranged as the slots to be formed.

10. The process as recited in claim 8, wherein said compressing plates are reciprocally identical, and said protrusions are straight and parallel to each other.

11. A flexible thermoinsulating device comprising a plurality of slots which is made by the process of:
obtaining a vacuum panel, said vacuum panel comprising a vacuum envelope inside which is disposed a filling material made up of at least a board of open cells of rigid polymeric foam; and
performing a localized compression operation along at least a linear portion of said panel, forming a slot on at least one face of a board of filling material adjacent to said envelope.
